(19) United States
(12) Patent Application Publication
(10) Pub. No.: US 2006/0045088 A1
(43) Pub. Date: Mar. 2, 2006

(54) Method of using Patricia tree and longest prefix match for policy-based route look-up

(75) Inventor: Tuyen Nguyen, San Ramon, CA (US)

Correspondence Address: DARBY & DARBY P.C., P.O. BOX 5257, NEW YORK, NY, 10150-6257, US

(73) Assignee: Nokia Inc., Irving, TX (US)

(21) Appl. No.: 10/926,741

(22) Filed: Aug. 25, 2004

(51) Int. Cl. H04L 12/56

(52) U.S. Cl. 370/392

(57) ABSTRACT

A method for using Patricia tree and longest prefix match for policy-based route look-up is described. Five route classes are determined based on a source address, a source address length, a destination address, a destination address length, and an ingress interface. Route classes are prioritized based on their content. A prefix for the first two route classes includes source and destination information. A prefix for the third and fourth route classes includes source information only. A prefix for the fifth route class includes destination information only. Four different route keys are constructed based on the route classes. The route keys are stored in a Patricia tree structure. For routing a data packet, a longest prefix match look-up is performed for a route key in descending priority order for the route classes.

### FIELD OF THE INVENTION

The present invention relates to network communications, and in particular, to a method of using Patricia tree and longest prefix match for policy-based route look-up.

### BACKGROUND

Data packets in telecommunication networks are transferred between a source and a destination through a number of nodes. A path to be taken by a data packet may be determined by one or more routers, which may determine the whole path or a portion of it based on a number of parameters. Commonly, the path is decided employing a routing algorithm. Standard routing algorithms include open shortest-path first (OSPF), routing information protocol (RIP), interior gateway routing protocol (IGRP), intermediate system to intermediate system (IS-IS), border gateway protocol (BGP), and the like.

Policy-based routing employs predetermined criteria based on a source address or subnet, a destination address or subnet, an ingress port, a size of the data packet, and the like, in determining the next hop for a particular data packet. Generally, routers maintain routing tables and forwarding tables. Routing tables may be employed to compute optimal routes, while forwarding tables may include information determining a data packet's destination to a next hop. Commonly, forwarding tables include one entry for a destination Internet Protocol (IP) address, a destination mask, and a corresponding next hop IP address. While the IP addresses may be in the 32-bit format, the mask determines which portion of the full IP address is to be employed in computation.

Look-up algorithms, such as longest prefix match algorithm, determine a route by searching for the next hop destination of a data packet, employing a limited search based on the destination address and the mask of the data packet.

Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 illustrates an environment in which one embodiment of the present invention may operate;

FIG. 2 illustrates a block diagram of a network device in which one embodiment of the present invention may be implemented;

FIG. 3 illustrates a diagram of route classes and their priority according to one embodiment of the present invention;

FIG. 4A illustrates a diagram of prefixes for different route classes;

FIG. 4B illustrates a diagram of route keys for different route classes; and

FIGS. 5A and 5B illustrate a flow diagram of a route look-up process according to one embodiment of the present invention.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Briefly stated, the present invention is directed to using Patricia tree and longest prefix match for policy-based route look-up. A Patricia tree is a simple data look-up structure that is commonly used in routing applications. A route key that includes routing information for a data packet are stored in a Patricia tree structure where each bit can be determined based on a branching decision at the preceding bit. When the route key is to be looked up, each bit of the route key is followed down the branches of the Patricia tree. The longest prefix match method selects a route key based on a matching of the route key with as many bits on the data structure as possible.

Generally, Patricia tree and longest prefix match does not allow for policy-based routing look-up's. The method may also require large amounts of memory and processing. One aspect of the present invention provides for performing a policy-based look-up employing Patricia tree and longest prefix match for each policy rule.

According to one embodiment of the present invention, five route classes are determined based on a source address or subnet, a destination address or subnet, and an ingress interface. Each route class is a category of routes based on at least one attribute of the route. The route classes are prioritized based on their attributes, which include a source address and a source mask length, a destination address and a destination mask length, and an ingress interface. The source address and the source mask length provide information associated with a source network and/or device from which the data packet originates and a length of the address that is to be used in a look-up operation. Similarly, the destination address and the destination mask length provide information associated with a destination network and/or device to which the data packet is to be delivered and a length of the destination address that is to be used in a look-up operation. Finally, the ingress interface provides information associated with an interface or port, where the data packet is to be received at the network device.

Three different types of prefixes are also determined for different route classes. Then four route keys are constructed based on the route classes. The route keys include various combinations of a prefix, a destination mask length, a source mask length, a destination address or subnet, a source address or subnet, and an ingress interface. The route keys are stored in a Patricia tree structure.

For routing a data packet, a look-up algorithm is employed that performs a longest prefix match based on the route class priorities. While examples of Internet Protocol (IP) addresses and IP structure are used in describing embodiments of the invention below, the invention is not so limited. Methods and algorithms desribed below may be implemented for other types of routing systems known to those skilled in the art.

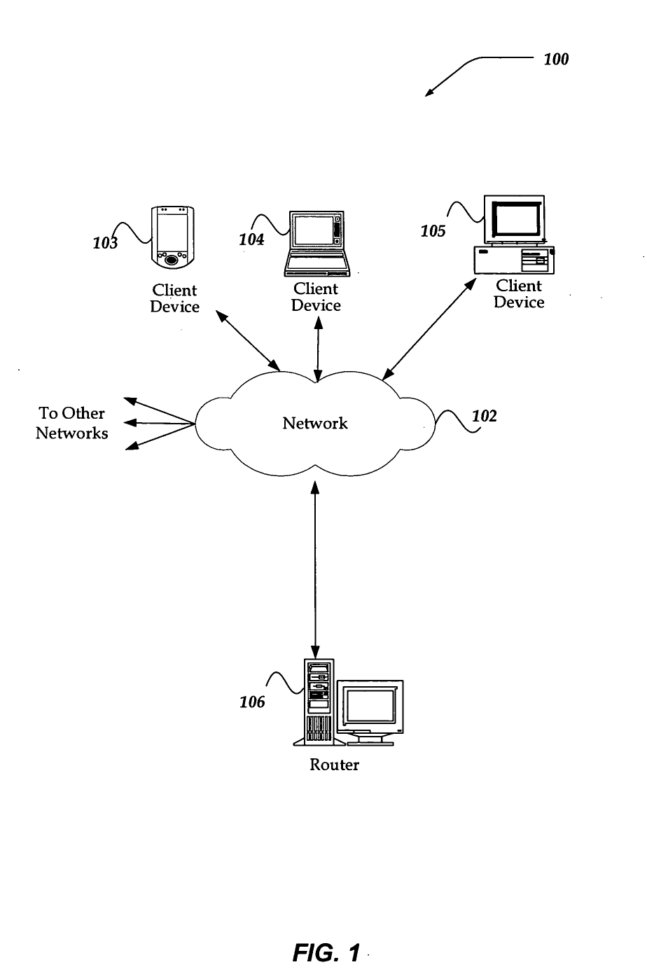

FIG. 1 illustrates an environment in which one embodiment of the present invention may operate. However, not all of these components may be required to practice the invention, and variations in the arrangement and type of the components may be made without departing from the spirit and scope of the invention.

As shown in the figure, system 100 includes network 102, client devices 103-105, and router 106. Network 102 represents any network including the Internet, and enables-communication between client devices 103-105, as well as between client devices 103-105 and network devices, including network devices connected to other networks that are in communication with network 102.

Generally, client devices 103-105 may include virtually any computing device capable of connecting to another computing device to send and receive information, including emails, and other interactive information. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, radio frequency (RF) devices, infrared (IR) devices, integrated devices combining one or more of the preceding devices, or virtually any mobile device. Similarly, client device 102 may be any device that is capable of connecting using a wired or wireless communication medium such as a PDA, POCKET PC, wearable computer, and any other device that is equipped to communicate over a wired and/or wireless communication medium.

Client devices 103-105 may further include a client application, that is configured to manage the actions described above in association with client devices 103-105. Moreover, client devices 103-105 may also include a web browser application, that is configured to enable an end-user to interact with other devices and applications, over network 102. In one embodiment, the web browser may be configured to provide various functions, including, but not limited to, authentication, ability to enable an end-user to customize a web browsing feature, and synchronization with another web browser application. The web browser may further enable inputs, such as a keyboard input, a mouse input, an audio input, and the like.

Network 102 is configured to couple client devices 103-105 among themselves, with other client devices, and to router 106. Network 102 may also be coupled to other networks and enable communication between devices connected to network 102 and devices connected to other networks. Network 102 is enabled to employ any form of computer readable media for communicating information from one electronic device to another. In one embodiment, network 102 is the Internet, and may include local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, to enable messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links.

Network 102 may further employ a plurality of wireless access technologies including, but not limited to, 2^{nd} generation (2G), 3rd generation (3G) radio access for cellular systems, Wireless-LAN, Wireless Router (WR) mesh, and the like. Access technologies such as 2G, 3G, and future access networks may enable wide area coverage for mobile devices, such as client device 102 with various degrees of mobility. For example, network 102 may enable a radio connection through a radio network access such as Global System for Mobil communication (GSM), General Packet Radio Services (GPRS), Enhanced Data GSM Environment (EDGE), Wideband Code Division Multiple Access (WCDMA), 802.16, and the like.

Furthermore, remote computers and other related electronic devices could be remotely connected to either LANs or WANs via a modem and temporary telephone link. In essence, network 102 includes any communication method by which information may travel between client devices 103-105 and other network devices.

Additionally, network 102 may include communication media that typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as, but not limited to, twisted pair, coaxial cable, fiber optics, wave guides, and other wired media and wireless media such as, but not limited to, acoustic, RF, infrared, and other wireless media.

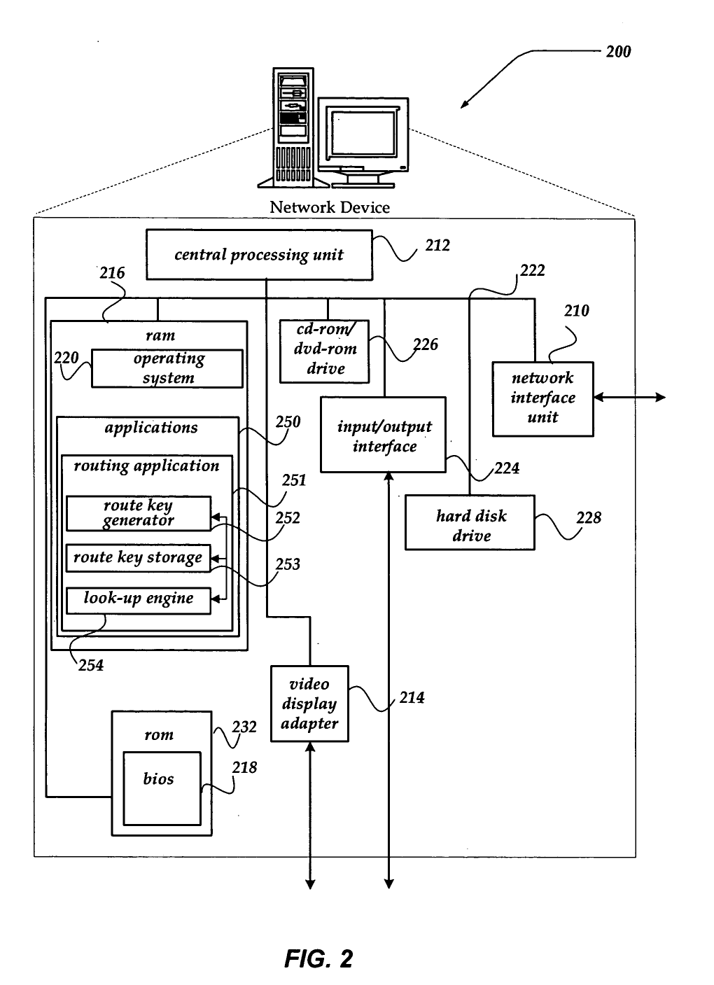

Router 106 is described in more detail below in conjunction with FIG. 2. Briefly, however, router 106 includes virtually any network device configured to provide routing services. As such, router 106 may be implemented on a variety of computing devices including personal computers, desktop computers, multiprocessor systems, microprocessor-based devices, network PCs, servers, network appliances, and the like.

Router 106 may further be configured to provide secured communication for interactions, various security and administrative control services, including but not limited to, authentication, load balancing, and the like. For example, router 106 may be configured to filter data received by a particular network device. In one embodiment, router 106 may communicate with other devices through a secure or unsecure channel.

FIG. 2 illustrates a block diagram of a network device 200, in which one embodiment of the present invention may be implemented. Network device 200 may include many more components than those shown. The components shown, however, are sufficient to disclose an illustrative embodiment for practicing the invention.

Network device 200 includes central processing unit 212, video display adapter 214, and a mass memory, all in communication with each other via bus 222. The mass memory generally includes RAM 216, ROM 232, and one or more permanent mass storage devices, such as hard disk drive 228, CD/DVD-ROM drive 226, tape drive, optical drive, and/or floppy disk drive (not shown). The mass memory stores operating system 220 for controlling the operation of network device 200. Any general-purpose operating system may be employed. As illustrated in FIG. 2, network device 200 also can communicate with the Internet, or some other communications network, such as network 102 in FIG. 1, via network interface unit 210, which is constructed for use with various communication protocols including the TCP/IP protocols. Network interface unit 210 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

RAM 216 also stores program code and data. One or more applications 250 are loaded into mass memory and run on operating system 220. Examples of application programs may include transcoders, schedulers, graphics programs, database programs, word processing programs, user interface programs, various security programs, and so forth. Applications 250 may further include routing application 251.

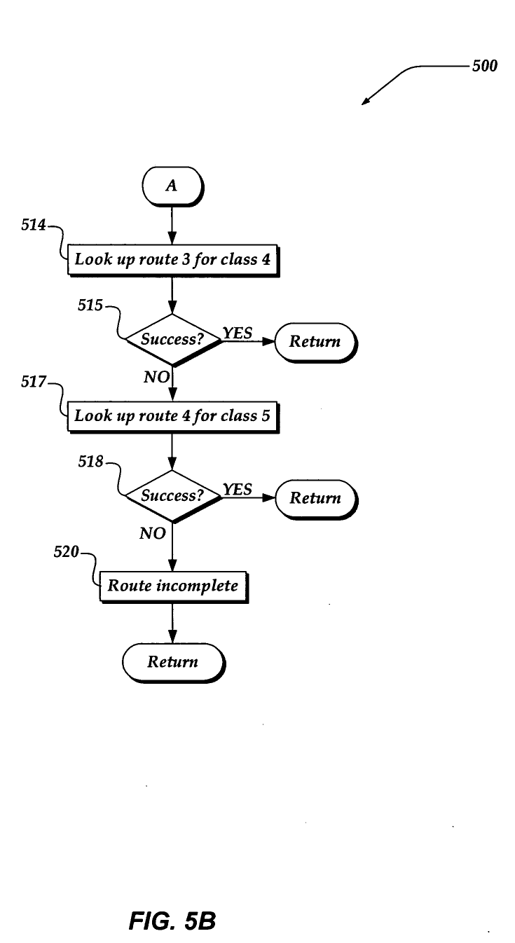

Routing application 251 may be configured to perform routing operations over network 102 of FIG. 1. In one embodiment, routing application 251 may include route key generator 252, route key storage 253, and look-up engine 254. Route key generator 252 may generate route keys based on route classes and routing information according to policy rules. As described in more detail below, four different route keys may be generated for five different classes of routes. Route key storage 253 may be employed to store route keys in a Patricia tree structure for later look-up. Look-up engine 254 may implement a routing look-up algorithm such as the algorithm described below in conjunction with FIGS. 5A and 5B.

Network device 200 may also include input/output interface 224 for communicating with external input or output devices, such as a mouse, keyboard, scanner, or other input or output devices not shown in FIG. 2.

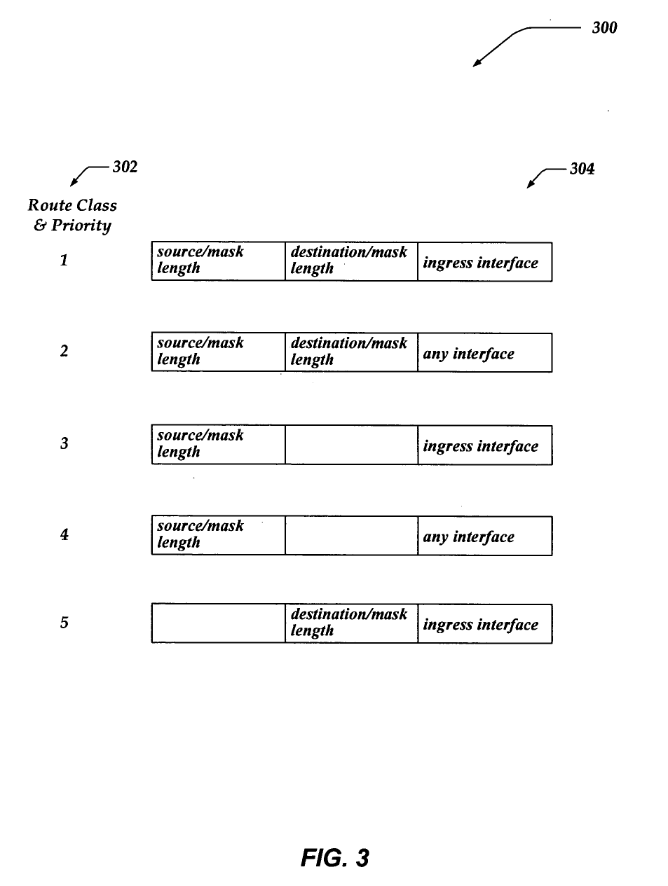

FIG. 3 illustrates diagram 300 of route classes and their priority according to one embodiment of the present invention. Diagram 300 includes route classes 302 and route information categories 304.

Five route classes may be determined based on a source address or subnet, a destination address or subnet, and an ingress interface index. This classification and prioritization enables policy-based routing for each class, while a simplified look-up algorithm such as Patricia tree and longest prefix match may be employed to look up a route key. Route classes 302 are prioritized based on information categories 304, which indicate information included for each route class.

A highest priority may be assigned to route class one. Route class one may include a source address and mask length, a destination address and mask length, and an ingress interface index. The source address and mask length provide information about a source subnet or network device for a data packet that is being routed. Similarly, the destination address and mask length provide information about a destination subnet or network device for the data packet that is being routed. The ingress interface index indicates a port of the destination network device, where the data packet is received. For the highest priority route class (one), a specific ingress interface index (port number) is provided for routing.

A second priority may be assigned to route class two. Route class two may include a source address and mask length, a destination address and mask length, and an ingress interface index. The source address and mask length and the destination address and mask length are similar to those in route class one. The ingress interface index for route class two, however, has a zero value indicating the data packet can be received at any port of the network device.

A third priority may be assigned to route class three. Route class three may include a source address and mask length and an ingress interface index. The source address and mask length is similar to those in route classes one and two. The destination address and mask length is not included for route class three. The ingress interface index for route class three has a non-zero value. Thus, a specific interface may be designated to indicate a port of the network device, where the data packet is received.

A fourth priority may be assigned to route class four. Route class four may include a source address and mask length, and an ingress interface index with a zero value. The source address and mask length is similar to those in route classes one and two. The ingress interface index has a zero value indicating the data packet may be received at any interface of the network device.

Finally, a fifth priority may be assigned to route class five. Route class five may include a destination address and mask length, and an ingress interface index. The destination address and mask length is similar to those in route classes one and two. The source address and mask length is not included for route class five. The ingress interface index for route class five may have any non-zero value. Thus, a specific interface may be designated to indicate a port of the network device, where the data packet is received.

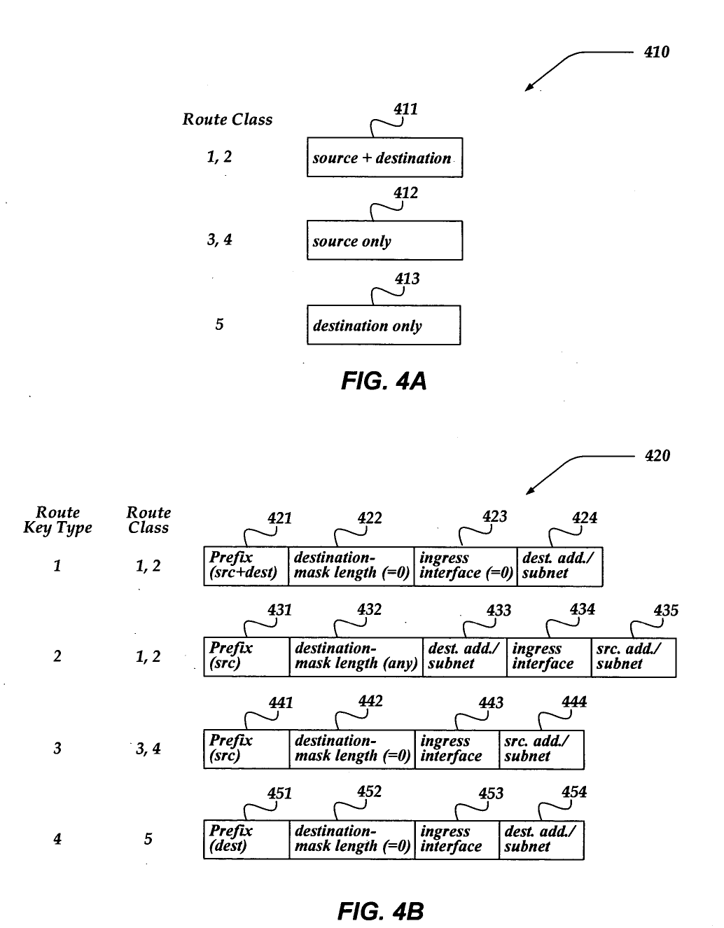

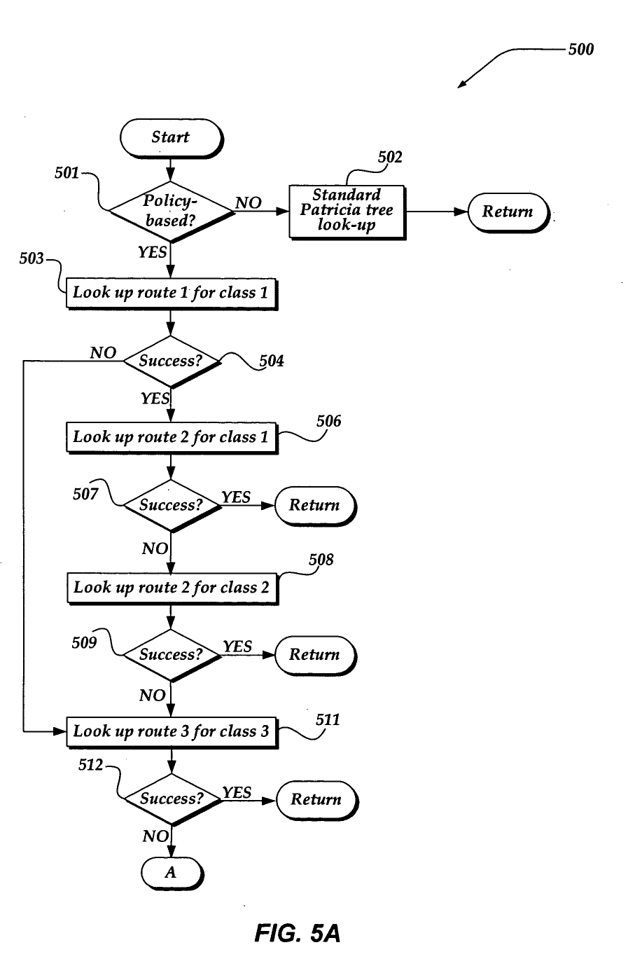

FIG. 4A illustrates diagram 410 of prefixes for different route classes. As described in more detail in conjunction with FIG. 4B, route keys may be constructed employing a prefix, a destination or source mask, an interface index, and a destination or source address. According to one embodiment of the present invention, three different types of prefixes may be employed in constructing route keys.

For route classes one and two, which have the highest priorities, prefix 411 may include source and destination information. For route classes three and four, prefix 412 may include source information only. For route class five, prefix 413 may include destination information only.

FIG. 4B illustrates diagram 420 of route keys for different route classes. According to one embodiment of the invention, four different types of route keys may be constructed based on the route classes and priorities.

As shown in the figure, each route key may be associated with one or more route classes. Furthermore, each route key may include categories of information. The categories of information employed for constructing the route key may be determined based on the route class that is associated with the route key.

A first type route key may be associated with route classes one and two. The first type route key may include prefix 421, destination mask length 422, ingress interface index 423, and destination address or subnet 424. Prefix 421 may include source and destination information. Destination mask length 422 is zero for this type of route key. Ingress interface index 423 is zero for this type of route key as well.

The final category of information for the first type route key is destination address or subnet 424. This category simply provides an address of a destination subnet or network device.

A second type route key may also be associated with route classes one and two. The second type route key may include prefix 431, destination mask length 432, destination address or subnet 433, ingress interface index 434, and source address and subnet 435. Prefix 431 may include source information only. Destination mask length 432 may have a mask length of destination address or subnet 424 for the first type of route key. Destination address or subnet 433 is similar to destination address and subnet 424 of the first type route key. Ingress interface index 434 may indicate an interface where data packet is received. A value of zero for ingress interface index 434 indicates any interface of the destination network device, at which the data packet is received. The second type route key may also include source address or subnet category 435 providing an address of a source subnet or network device for the data packet.

A third type route key may be associated with route classes three and four. The third type route key may include prefix 441, destination mask 442, ingress interface index 443, and source address and subnet 444. Prefix 441 may include source information only. Destination mask length 442 is zero for this type of route key indicating no destination information. Ingress interface index 443 may include a specific port number, zero for any port of the network device, and the like. The third type route key also includes source address and subnet 444 indicating an address of a source subnet or network device for the data packet.

A fourth type route key may be associated with route class five. The fourth type route key may include prefix 451, source mask length 452, ingress interface index 453, and destination address or subnet 454. Prefix 451 may include destination information only. Source mask length 452 is zero for this type of route key indicating no source information. Ingress interface index 453 may include a specific port number, zero for any port of the network device. The fourth type route key also includes destination address or subnet 454 as its final category, indicating an address of a destination subnet or network device for the data packet.

FIGS. 5A and 5B illustrate a flow diagram generally showing search process 500. Process 500 may, for example, be implemented in routing application 251 of FIG. 2.

As shown in FIG. 5A, process 500 begins after a start block, at block 501, where a decision is made whether the search is a policy-based look-up or not. If the decision is negative, processing proceeds to block 502. If the decision is affirmative, processing proceeds to block 503.

At block 502, a standard longest prefix match look-up is performed on a Patricia tree structure. Because the route search at this block is not policy-based, other search methods may also be implemented.

At block 503, a longest prefix match look-up is performed for a first type route key. Accordingly, the route key for this step of the search may include a prefix comprising source and destination information, a destination mask length of zero, an ingress interface index of zero, and a destination address with subnet information (if any). Processing then proceeds to decision block 504.

At block 504, a decision is made whether the search at block 503 was successful or not. If the decision is negative, processing proceeds to block 511. If the decision is affirmative, the search is not complete yet and processing proceeds to block 506.

At block 506, a longest prefix match look-up is performed for a second type route key based on the first route class. Accordingly, the route key for this step of the search may include a prefix comprising source information only, a destination mask length found from the first type route key lookup, a destination address or subnet information, an ingress interface index indicating the interface where the data packet is received, and a source address or subnet information.

The following examples illustrate determination of route keys for route class 1 for a set of given route attributes.

Search Example 1 for Route Class 1 (Destination Subnet and Source Subnet)

Attributes:
destination address=201.226.1.0
destination mask=24
source address=202.226.2.0
source mask=24
ingress interface index=99
   Based on the given attributes, two route keys may be determined for the first and second searches:
route key 1=3.0.0.0.0.0.201.226.1.0; length=72
route key 2=1.24.0.0.0.99.201.226.1.0.202.226.2.0; length=104
   Search Example 2 for Route Class 1 (Destination Subnet and Source Network Device)
Attributes:
destination address=201.226.1.0
destination mask=24
source address=202.226.2.22
source mask=32
ingress interface index=99
   Based on the given attributes, two route keys may be determined for the first and second searches:
route key 1=3.0.0.0.0.0.201.226.1.0; length=72
route key 2=1.24.0.0.0.99.201.226.1.0.202.226.2.22; length=112
   Search Example 3 for Route Class 1 (Destination Network Device and Source Subnet)
Attributes:
destination address=201.226.1.11
destination mask=32
source address=202.226.2.0
source mask=24
ingress interface index=99
   Based on the given attributes, two route keys may be determined for the first and second searches:
route key 1=3.0.0.0.0.0.201.226.1.11; length=80
route key 2=1.32.0.0.0.99.201.226.1.11.202.226.2.0; length=104

At block 507, a decision is made whether the search at block 506 was successful or not. If the decision is affirmative, processing returns to a calling process. If the decision is negative, processing proceeds to block 508.

At block 508, a longest prefix match look-up is performed for a second type route key based on the second route class. Accordingly, the route key for this step of the search may include a prefix comprising source information only, a destination mask length found from the first type route key look-up, a destination address or subnet information, an ingress interface index of zero indicating any port, and a source address or subnet information. Processing then proceeds to decision block 509.

Search Example 1 for Route Class 2 (Destination Subnet and Source Subnet)

Attributes:
destination address=201.226.1.0
destination mask=24
source address=202.226.2.0
source mask=24
ingress interface index=0
Based on the given attributes, two route keys may be determined for the first and second searches:
route key 1=3.0.0.0.0.0.201.226.1.0; length=72
route key 2=1.24.0.0.0.0.201.226.1.0.202.226.2.0; length=104
   Search Example 2 for Route Class 2 (Destination Subnet and Source Network Device)
Attributes:
destination address=201.226.1.0
destination mask=24
source address=202.226.2.22
source mask=32
ingress interface index=0
Based on the given attributes, two route keys may be determined for the first and second searches:
route key 1=3.0.0.0.0.0.201.226.1.0; length=72
route key 2=1.24.0.0.0.0.201.226.1.0.202.226.2.22; length=112
   Search Example 3 for Route Class 2 (Destination Network Device and Source Subnet)
Attributes:
destination address=201.226.1.11
destination mask=32
source address=202.226.2.0
source mask=24
ingress interface index=0
Based on the given attributes, two route keys may be determined for the first and second searches:
route key 1=3.0.0.0.0.0.201.226.1.11; length=80
route key 2=1.32.0.0.0.0.201.226.1.11.202.226.2.0; length=104

At block 509, a decision is made whether the search at block 508 was successful or not. If the decision is affirmative, processing returns to a calling process for further actions. If the decision is negative, processing proceeds to block 511.

At block 511, a longest prefix match look-up is performed for a third type route key based on a third route class. Accordingly, the route key for this step of the search may include a prefix comprising source information only, a destination mask length of zero, an ingress interface index, and a source address or subnet information. Processing then proceeds to decision block 512.

Search Example 1 for Route Class 3 (Source Subnet)

Attributes:
source address=202.226.2.0
source mask=24
ingress interface index=99
Based on the given attributes, one route key may be determined:
route key=1.0.0.0.0.99.202.226.2.0; length=72
   Search Example 2 for Route Class 3 (Source Network Device)
Attributes:
source address=202.226.2.22
source mask=32
ingress interface index=99
Based on the given attributes, one route key may be determined:
route key=1.0.0.0.0.99.202.226.2.22; length=80

At block 512, a decision is made whether the search at block 511 was successful or not. If the decision is affirmative, processing returns to a calling process for further actions. If the decision is negative, processing proceeds to block 514 in FIG. 5B.

FIG. 5B illustrates a continuation of process 500 that follows a negative decision at block 512 of FIG. 5A.

Process 500 continues at block 514, where a longest prefix match look-up is performed for the third type route key based on a fourth route class. Accordingly, the route key for this step of the search may include a prefix comprising source information only, a destination mask length of zero, an ingress interface index of zero indicating any interface, and a source address or subnet information. Processing then proceeds to decision block 515.

Search Example 1 for Route Class 4 (Source Subnet)

Attributes:
source address=202.226.2.0
source mask=24
ingress interface index=0
Based on the given attributes, one route key may be determined:
route key=1.0.0.0.0.0.202.226.2.0; length=72
   Search Example 2 for Route Class 4 (Source Network Device)
Attributes:
source address=201.226.2.22
source mask=32
ingress interface index=0
Based on the given attributes, one route key may be determined:
route key=1.0.0.0.0.0.202.226.2.22; length=80

At block 515, a decision is made whether the search at block 514 was successful or not. If the decision is affirmative, processing returns to a calling process for further actions. If the decision is negative, processing proceeds to block 517.

At block 517, a longest prefix match look-up is performed for a fourth type route key based on a fifth route class. Accordingly, the route key for this step of the search may include a prefix comprising destination information only, a destination mask length of zero, an ingress interface index, and a destination address or subnet information. Processing then proceeds to decision block 518.

Search Example 1 for Route Class 5 (Destination Subnet)

Attributes:
destination address=201.226.1.0
destination mask=24
ingress interface index=99
Based on the given attributes, one route key may be determined:
route key=2.0.0.0.0.99.201.226.1.0; length=72
   Search Example 2 for Route Class 5 (Destination Network Device)
Attributes:
destination address=201.226.1.11
destination mask=32
ingress interface index=99
Based on the given attributes, one route key may be determined:
route key=2.0.0.0.0.99.201.226.1.11; length=80

At block 518, a decision is made whether the search at block 517 was successful or not. If the decision is affirmative, processing returns to a calling process for further actions. If the decision is negative, processing proceeds to block 520.

At block 520 a determination is made that the route search was unsuccessful. In one embodiment, the determination at block 520 may be followed by other actions such as notifying a source for the data packet, re-initiating the algorithm, and the like. Processing then proceeds to a calling process for further actions.

It will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks. Moreover, the invention is not limited to the above listed examples, and other implementations may be employed, without departing from the spirit or scope of the invention.

Accordingly, blocks of the flowchart illustrations support combinations of means for performing the specified actions, combinations of steps for performing the specified actions and program instruction means for performing the specified actions. It will also be understood that each block of the flowchart illustrations, and combinations of blocks in the flowchart illustrations, can be implemented by special purpose hardware-based systems, which perform the specified actions or steps, or combinations of special purpose hardware and computer instructions.

We claim:

1. A method for routing a data packet over a network, comprising:
determining a plurality of route classes based, in part, on at least two route attributes, wherein each route class is assigned a priority;
determining a plurality of route keys that are associated with the plurality of route classes; and
determining routing information for the data packet by performing a plurality of longest prefix match (LPM) searches for the plurality of route keys associated with the data packet based, in part, on the assigned priority of route classes.

2. The method of claim 1, wherein the at least two attributes include a destination address and an associated destination mask length, a source address and an associated source mask length, and an ingress interface index.

3. The method of claim 1, wherein the plurality of route classes comprise:
a first route class that includes a source address and a source mask length, a destination address and a destination mask length, and an ingress interface index;
a second route class that includes a source address and a source mask length, a destination address and a destination mask length, and a zero value for the ingress interface index;
a third route class that includes a source address and a source mask, and an ingress interface index indicating any interface;
a fourth route class that includes a source address and source mask length, and a zero value for ingress interface index indicating any interface; and
a fifth route class that includes a destination address and a destination mask length, and an ingress interface index.

4. The method of claim 3, wherein the first route class is assigned a highest priority, and the other route classes are assigned lower priorities in a descending order.

5. The method of claim 3, further comprising:
if a value of the ingress interface index is other than zero, directing the data packet to a destination device that is defined by an interface, where the data packet is received; and
if the value of the ingress interface device is zero, directing the data packet received at any interface to the destination device.

6. The method of claim 1, wherein the LPM search is performed on a Patricia tree data structure.

7. The method of claim 3, wherein the route keys are constructed such that:
a first route key includes a prefix that comprises a source and a destination information, a zero value for a destination mask length, a zero value for the ingress interface index, and the destination address and a destination subnet information;
a second route key includes a prefix that comprises the source information, the destination mask length, the destination address and the destination subnet information, the ingress interface index, and the source address and the source subnet information;
a third route key includes a prefix that comprises the source information, a zero value for the destination mask length, the ingress interface index, and the source address and the source subnet information; and
a fourth route key includes a prefix that comprises the destination information, a zero value for the source mask length, a non-zero value for the ingress interface index, and the destination address and the destination subnet information.

8. The method of claim 7, wherein:
the first route key and the second route key are associated with the first and the second route classes;
the third route key is associated with the third and the fourth route classes; and
the fourth route key is associated with the fifth route class.

9. The method of claim 7, wherein the ingress interface index includes at least one of a zero value and a value other than zero.

10. The method of claim 7, wherein determining the routing information comprises:
performing a first LPM search for the first route key;
if the first search is successful, proceeding to a second LPM search; and
if the first search is not successful, proceeding to a fourth LPM search.

11. The method of claim 10, wherein determining routing information further comprises:
performing the second LPM search for the second route key based on the first route class;
if the second search is successful, routing the data packet based on a route key that is determined as a result of the second LPM search;
if the second search is not successful, performing a third LPM search for the second route key based on the second route class;
if the third LPM search is successful, routing the packet based on the route key that is determined as a result of the third LPM search; and
if the third search is not successful, proceeding to the fourth LPM search.

12. The method of claim 11, wherein determining routing information further comprises:
performing the fourth LPM search for the third route key based on the third route class;
if the fourth search is successful, routing the packet based on the route key that is determined as a result of the fourth LPM search; and
if the fourth search is not successful, proceeding to a fifth LPM search.

13. The method of claim 12, wherein determining routing information further comprises:
performing the fifth LPM search for the third route key based on the fourth route class;
if the fifth search is successful, routing the packet based on the route key that is determined as a result of the fifth LPM search; and
if the fifth search is not successful, proceeding to a sixth LPM search.

14. The method of claim 13, wherein determining routing information further comprises:
performing the sixth LPM search for the fourth route key based on the fifth route class;
if the sixth search is successful, routing the packet based on the route key that is determined as a result of the sixth LPM search; and
if the sixth search is not successful, terminating the search.

15. The method of claim 10, wherein determining routing information further comprises:
determining whether the routing is a policy-based routing;
if the routing is not policy-based routing, proceeding to an LPM search on a Patricia tree structure based on a single route key information; and
if the routing is policy-based routing, proceeding to the first LPM search.

16. A network device for routing a data packet over a network, comprising:
a memory device that is arranged to store routing information including a source address, a source mask length, a destination address, a destination mask length, and an ingress interface index; and
a processor that is configured to perform actions including:
determining five route classes based on a predetermined combination of a source address, a source mask length, a destination address, a destination mask length, and an ingress interface index;
determining four route key structures based on a predetermined combination of a prefix, a destination address and a destination subnet information, a source address and a source subnet information, a destination mask length, a source mask length, and an ingress interface index;
performing a plurality of longest prefix match searches based on a Patricia tree structure, wherein each search after a first search is performed if the previous search is unsuccessful in determining the associated route key;
routing the data packet based on the route key that is determined by a successful LPM search; and
terminating the routing, if a sixth LPM search is unsuccessful.

17. The network device of claim 16, wherein the route classes include:
a first route class that includes a source address and a source mask length, a destination address and a destination mask length, and an ingress interface index;
a second route class that includes a source address and a source mask length, a destination address and a destination mask length, and a zero value for the ingress interface index;
a third route class that includes a source address and a source mask length, and an ingress interface index;
a fourth route class that includes a source address and source mask length, and a zero value for ingress interface index; and
a fifth route class that includes a destination address and a destination mask length, and an ingress interface index.

18. The network device of claim 16, wherein the route key structures include:
a first route key structure that includes a zero value for a destination mask length, a zero value for the ingress interface index, and the destination address, a destination subnet information, and a prefix comprising a source and a destination information;
a second route key structure that includes the destination mask length, the destination address and the destination subnet information, the ingress interface index, and the source address and the source subnet information, and a prefix comprising the source information;
a third route key structure that includes a zero value for the destination mask length, the ingress interface index, and the source address and the source subnet information, and a prefix comprising the source information; and
a fourth route key structure that includes a zero value for the source mask length, the ingress interface index, the destination address and the destination subnet information, and a prefix comprising the destination information.

19. The network device of claim 16, wherein performing a plurality of longest prefix match searches includes:
performing a first LPM search for the first route key;
if the first search is successful, proceeding to a second LPM search; and
if the first search is not successful, proceeding to a fourth LPM search.

20. The network device of claim 19, wherein performing a plurality of longest prefix match searches further includes:
performing the second LPM search for the second route key based on the first route class;
if the second search is successful, routing the data packet based on a route key that is determined as a result of the second LPM search;
if the second search is not successful, performing a third LPM search for the second route key based on the second route class;
if the third LPM search is successful, routing the packet based on the route key that is determined as a result of the third LPM search; and
if the third search is not successful, proceeding to the fourth LPM search.

21. The network device of claim 20, wherein performing a plurality of longest prefix match searches further includes:
performing the fourth LPM search for the third route key based on the third route class;
if the fourth search is successful, routing the packet based on the route key that is determined as a result of the fourth LPM search; and
if the fourth search is not successfuil, proceeding to a fifth LPM search.

22. The network device of claim 21, wherein performing a plurality of longest prefix match searches further includes:
performing the fifth LPM search for the third route key based on the fourth route class;
if the fifth search is successful, routing the packet based on the route key that is determined as a result of the fifth LPM search; and
if the fifth search is not successful, proceeding to the sixth LPM search.

23. The network device of claim 22, wherein performing a plurality of longest prefix match searches further includes:
performing the sixth LPM search for the fourth route key based on the fifth route class.

24. A network device for routing a data packet over a network, comprising:
a means for determining five route classes based on a predetermined combination of a source address, a source mask length, a destination address, a destination mask length, and an ingress interface index;
a means for determining four route key structures based on a predetermined combination of a prefix, a destination address and a destination subnet information, a source address and a source subnet information, a destination mask length, a source mask length, and an ingress interface index, wherein:
the first and the second route keys are associated with the first and second route classes;
the third route key is associated with the third and fourth route classes; and
the fourth route key is associated with the fifth route class;
a means for performing a longest prefix match search based on a Patricia tree structure, wherein each search after a first search is performed is the previous search is unsuccessful in determining the associated route key, and wherein:
the first search is for the first route key;
a second search is for the second route key based on the first route class;
a third search is for the second route key based on the second route class;
a fourth search is for the third route key based on the third route class;
a fifth search is for the third route key based on the fourth route class; and
a sixth search is for the fourth route key based on the fourth route class;
a means for routing the data packet based on the route key that is determined by a successful LPM search; and
a means for terminating the routing, if the sixth LPM search is unsuccessful.
